(19) United States
(12) Patent Application Publication
(10) Pub. No.: US 2007/0118526 A1
(43) Pub. Date: May 24, 2007

(54) Internet-based book rent system

(76) Inventors: Jennifer Jean Gifford, Blacksburg, VA (US); Alfredo Alejandro Romero-Aguirre, Blacksburg, VA (US)

Correspondence Address: Alfredo Romero, 300 Allegheny St. 12, Blacksburg, VA, 24060, US

(21) Appl. No.: 11/284,230

(22) Filed: Nov. 22, 2005

(51) Int. Cl. G06F 17/30; G06F 7/00

(52) U.S. Cl. 707/9

(57) ABSTRACT

The limited availability of textbooks at on campus and public libraries creates a problem for students whose decision of not buying a book relies upon a financial constraint or the knowledge that the books would be relevant just for a limited period of time. This problem is exacerbated when the books are of recent publication and the libraries are unable to provide the most up to date editions. This problem is resolved via a book rental system based on an electronic list of a stock of textbooks provided by the owners of used copies of the textbooks which can be rented for a specific period of time by the customers and obtained personally from the owners or by mail

### FIELD OF THE INVENTION

A book rental system based on an electronic list of a stock of textbooks provided by the owners which can be rented for a specific period of time by the customers and obtained personally from the owners or by mail. A control system that (I) keeps track of the availability, current holders, and rental due dates of the books; (II) keeps track of the registered users; (III) establishes the fees and processes the payments; (IV) arranges the delivery of the books. Other and further features will become apparent hereinafter.

### BACKGROUND OF THE INVENTION

The limited availability of textbooks at on campus and public libraries creates a problem for students whose decision of not buying a book relies upon a financial constraint or the knowledge that the books would be relevant just for a limited period of time. This problem is exacerbated when the books are of recent publication and the libraries are unable to provide the most up to date editions. The current alternative is to obtain used books and then resell them at the end of the period for a fraction of the price paid.

The proposed rental system will enable the customers to obtain and use books for a specific period of time by paying a fee.

### SUMMARY OF THE INVENTION

The system relies on an online database that lists the available books for rent, the relevant field of use, and suggested alternative books to rent which are potentially relevant to the field of use. Owners can access the database and publish the list of books they would like to rent, specifying the extension of the period of the rental and the price of the rental per period. Customers can access the database and select the books they would like to rent and for how many periods they would like to rent them. The fees are charged when the customer accepts the agreements of the rental. The owner is informed that the book has been rented and agrees to deliver the book(s) by either sending it (them) by mail or by personally meeting with the customer at a preespecified location.

Before the rental period expires, a reminder of the due date will be sent to the customer. The customer must make sure that the return of the book(s) initiates not after the due date of the rental period. This can be granted by personally returning the book to the owner at a specific location or by verifying that the postal seal on the returned envelope shows a date no later than the due date. Once the books are recovered, the owner may decide to re-list the item(s).

### BRIEF DESCRIPTION OF THE DRAWINGS

FIG. 1. The Status Screen has three components, 1) The user information component, 2) The list of the books rented (if any), 3) The list of books for rent.

FIG. 2. The Posting Screen has three components, 1) The information of the book to be for rent, 2) The methods available for delivery, 3) The rental price per period. It also includes a decision node to confirm the rental of the book (a button) or a way to cancel the process (a button).

FIG. 3. The Search Screen has two components, 1) The search criteria, 2) The search results

FIG. 4. The Review Screen has one component that summarizes the relevant information of the book, the method of payments and delivery, and the price. It also has two decision nodes, one option to rent the book (a button) and one option to cancel the process (a button).

FIG. 5. The Transaction Screen has one component that summarizes the relevant information of the book and the methods of delivery and payment selected. It also has two decision nodes, one to proceed with the completion of the transaction (a button), and the other to cancel the process (a button)

### DETAILED DESCRIPTION OF THE INVENTION

Description of the Database

In order to be able to rent and/or post books, owners and customers must be registered in the database. This is accomplished by providing personal information of the users directly in the database and by choosing an identifying nickname. One important feature of the information is the contact information in the way that the name and address must be verified. Once the information is verified, the potential users obtain access to the database.

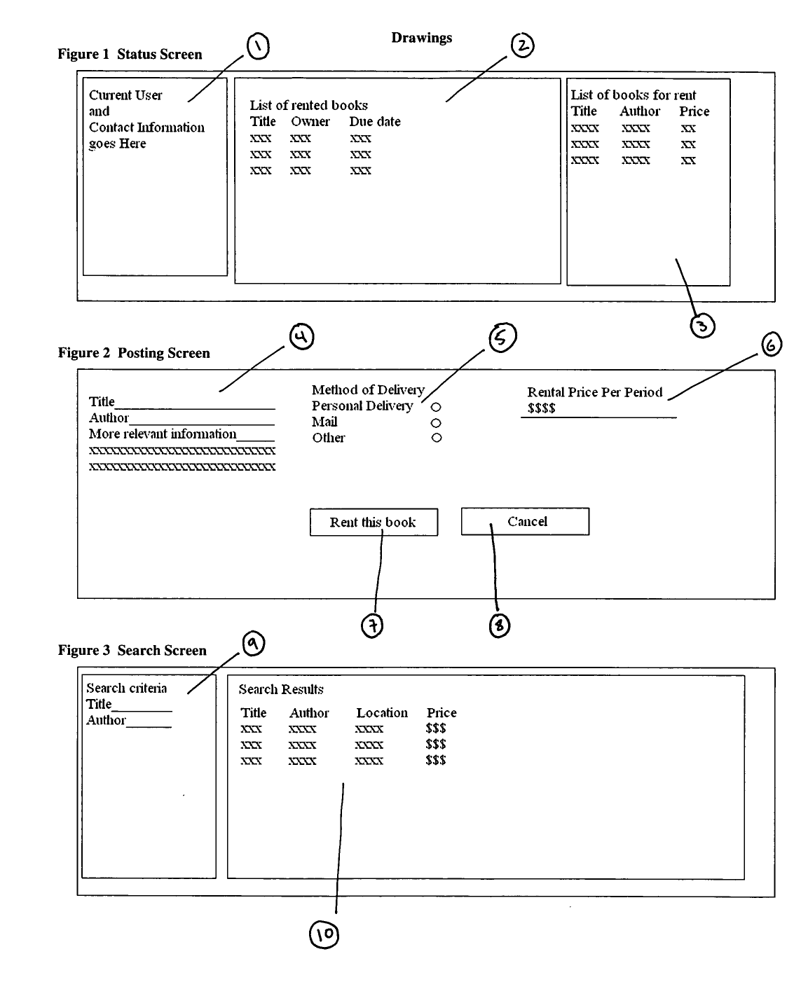

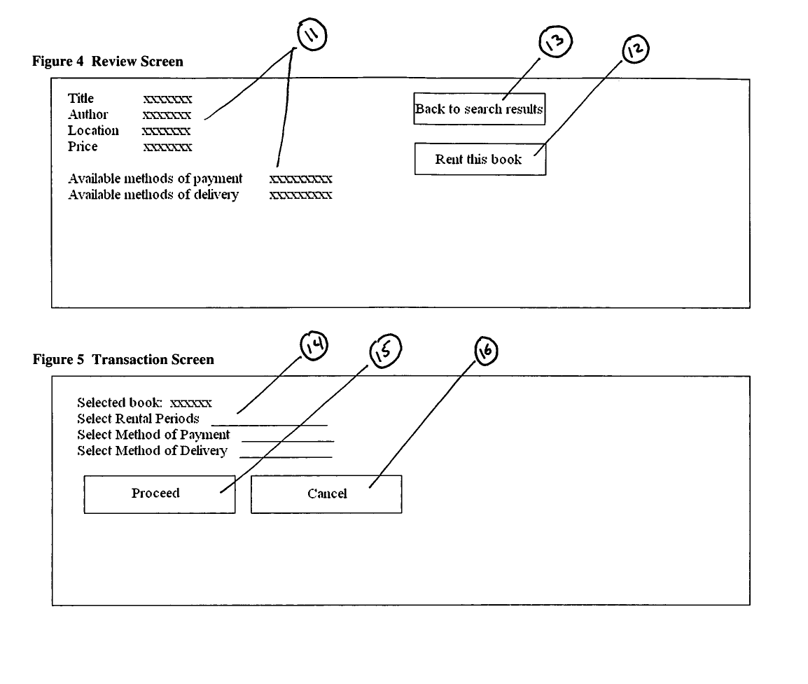

The database interface has different screens: The status screen (FIG. 1), the search screen (FIG. 2), the post screen (FIG. 3), the review screen (FIG. 4), and the transaction screen (FIG. 5).

The status screen provides the contact information of the user (1), the list of books the user has posted for rental (3), and the list of books in possession of the user (2), including their due date.

The posting screen is the place where the books are listed for rental. In this screen the relevant information of the book is provided (4). Such information includes title, author(s), ISBN, edition, publisher, and year. Information regarding the condition of the book is also entered. Also additional information can be provided such as what course the book was used for, the major of the owner, and comments of the owner regarding the book and suggested additional books helpful for the appreciation of the book. The method of delivery and the method of payments options are selected (5). The price of rental is established here (6). The rental period unit is a month. Once all the fields have been provided, the owner either accepts to post the book (7) or not (8). Once the book is posted, a posting fee is charged to the account of the user.

The search screen is the place where books for rent are searched. In this screen, the books can be sought using a variety of options such as title, ISBN, author, topic, or class (9). Once the books are found, a list of the available books is displayed together with the location of the book and the nickname of the current users (10). Each book can be reviewed in the review screen.

The review screen provides all the information of the book, the price of rental, the condition of the book and the comments provided by the owner (11). The customer can decide to rent the reviewed book (12) or go back to the search screen (13).

The transaction screen allows the customer to select the number of periods for rental, the method of payment, and the method of delivery (14). Once this information is entered, the customer can decide to either proceed and finalize the transaction (15) or cancel the transaction (16).

Description of the Method of Payment.

The owner provides the options available to the customer regarding the method of payment. Such options include, but are not limited to, personal checks, money orders, credit cards, or any other electronic payment system. The customer observes the options of payment available and decides the most appropriate to undertake the transaction.

Description of the Delivery and Return Process

The owner provides the options available to the customer regarding the method of delivery and return. Such options include, but are not limited to, personal delivery, mail delivery, or any other mean of physical delivery. The customer observes the options of delivery and selects the most convenient. One week before the due date of the rental is approaching, the customer will be notified of the proximity of the due date and reminded that a fine for the total of one month's rent will be charged if the book is sent back after the due date. When the book was sent can be verified by the date of the postal seal or any other sent date identifier.

Description of the Transaction Process

Once the customer has selected the book, the method of payment, and the method of delivery, the customer must accept the terms of the agreement. The rental period starts at that moment. The book is automatically unlisted form the data base. The customer must honor the terms of the agreement as soon as possible. The owner will deliver the book by the selected delivery method immediately after payment is received.

I claim:

1. An internet-based book and textbook (herein “books”) rent system containing an electronic database that can be accessed with a computer or a similar device via a network, an intranet or the internet (herein “online”), where registered owners of books (herein “owners”) list the books that are for rent and where registered renters (herein “customers”) select to rent them at a specified price for a specified period of time.

2. A system according to claim (1) that posses an electronic interface that allows the users to interact with the electronic database by providing searching, posting, reviewing, and transaction capabilities.

3. A system according to claim (1) that keeps track of the users of the system by collecting their contact information, academic information (if available), and financial information.

4. A system according to claim (1) that lists the books that are available for rent based on several physical and qualitative characteristics of the books, and un-lists the books once they have been rented

5. A system according to claim (1) that keeps track of the location of the books, the due dates of the books, and the terms of the rental agreement.

6. A system according to claim (1) that provides the means for billing the users of the system

7. A system according to claim (1) that provides the means for delivery and return of the rental books
